(19) United States
(12) Patent Application Publication
(10) Pub. No.: US 2021/0321629 A1
(43) Pub. Date: Oct. 21, 2021

(54) CAKE MARKING DEVICE

(71) Applicant: Cynthia Goodwin, Owensboro, KY (US)

(72) Inventor: Cynthia Goodwin, Owensboro, KY (US)

(21) Appl. No.: 16/852,495

(22) Filed: Apr. 19, 2020

(51) Int. Cl. A21C 15/04; B26D 3/24

(52) U.S. Cl. CPC A21C 15/04; B26D 3/245; B26D 3/24

(57) ABSTRACT

A cake cutting device, including a main body including a plurality of outer blades disposed on a perimeter of the main body, a plurality of inner blades perpendicularly disposed away from at least one pair of the plurality of outer blades, and a plurality of cake forming apertures disposed between the plurality of outer blades and the plurality of inner blades to form a size and a shape of slices of the cake therein, a cutting assembly disposed on at least a portion of a bottom surface of the main body to cut a cake in response to contacting the cake, and a plurality of handles removably connected to at least a portion of the main body to facilitate gripping thereof.

### BACKGROUND

### 1. Field

The present general inventive concept relates generally to a marking device, and particularly, to a cake marking device.

### 2. Description of the Related Art

Sheet cakes are delectable desserts many people take pleasure in consuming, often during birthday parties and/or other special events, etc. However, when it's time to cut the cake, the person in charge of cutting the cake may not be certain of the amount of people the cake will serve. Still, other individuals might not be adept in cutting the slices evenly for serving guests.

Generally, the person in charge of cutting the cake will use a knife and/or a cake server utensil. The knife and/or the cake server utensil is limited because each utensil is limited to making one cut at a time and is dependent on the person's cutting skill.

Therefore, there is a need for a cake marking device that marks a cake so that the cake may be cut into even shapes without relying on the person's cutting skill.

### SUMMARY

The present general inventive concept provides a cake marking device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a cake marking device, including a main body including a plurality of outer blades disposed on a perimeter of the main body, a plurality of inner blades perpendicularly disposed away from at least one pair of the plurality of outer blades, and a plurality of cake forming apertures disposed between the plurality of outer blades and the plurality of inner blades to form a size and a shape of slices of the cake therein, a marking assembly disposed on at least a portion of a bottom surface of the main body to mark at least a top surface of a cake in response to contacting the cake, and a plurality of handles removably connected to at least a portion of the main body to facilitate gripping thereof.

Each of the plurality of outer blades may include at least one end receiving groove disposed on at least a portion a surface of each of the plurality of outer blades to receive at least one end of at least one of the plurality of inner blades therein.

The end receiving groove may be recessed with respect to the surface of each of the plurality of outer blades.

The plurality of inner blades may include a first set, and a second set perpendicularly disposed with respect to the first set.

Each of the plurality of inner blades may include at least one upper groove disposed on at least a portion of a top surface of each of the plurality of inner blades, and at least one lower groove disposed on at least a portion of a bottom surface of each of the plurality of inner blades to receive the at least one upper groove therein, such that the at least one upper groove and the at least one lower groove are locked.

At least a portion of the main body may at least partially deform in response to contact with the cake.

The marking assembly may be a serrated edge.

The marking assembly may be a plain edge.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top isometric view of a cake marking device, according to an exemplary embodiment of the present general inventive concept;

FIG. 2A illustrates a side view of an outer blade with an end receiving groove, according to an exemplary embodiment of the present general inventive concept;

FIG. 2B illustrates a side view of an inner blade with an upper groove, according to an exemplary embodiment of the present general inventive concept;

FIG. 2C illustrates a side view of the inner blade with a lower groove, according to an exemplary embodiment of the present general inventive concept; and

FIG. 3 illustrates a top view of the cake marking device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Cake Marking Device 100
Main Body 110
Outer Blades 111
End Receiving Groove 111a
Inner Blades 112
Upper Groove 112a
Lower Groove 112b
Cake Forming Apertures 113
Marking Assembly 120
Handles 130

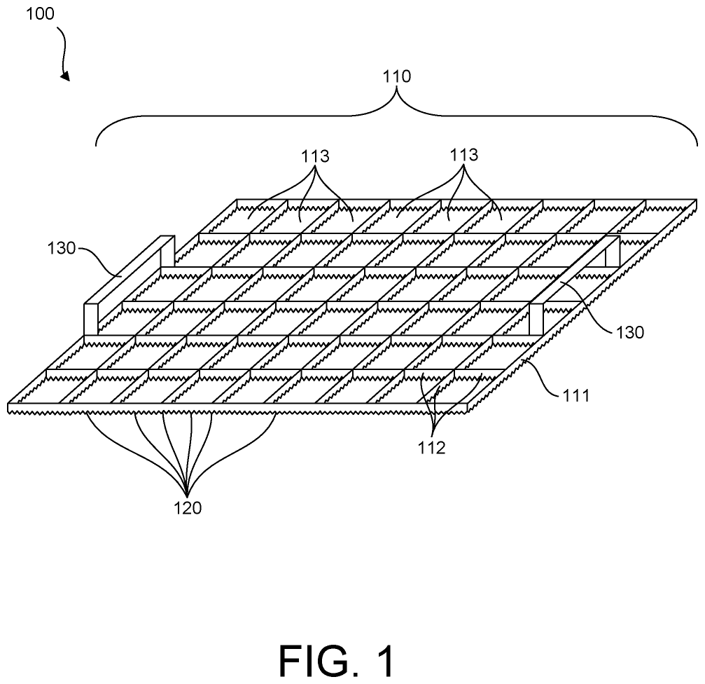

FIG. 1 illustrates a top isometric view of a cake marking device 100, according to an exemplary embodiment of the present general inventive concept.

The cake marking device 100 may be constructed from at least one of plastic, plastic, fiberglass, wood, and rubber, etc., but is not limited thereto. For example, the plastic may be food grade durable, such that the plastic may resist damage from contact with food. Also, the cake marking device 100 may be stainless steel and/or any other metal used with food handling.

The cake marking device 100 may include a main body 110, a marking assembly 120, and a plurality of handles 130, but is not limited thereto.

Referring to FIG. 1, the main body 110 is illustrated to have a rectangular shape. However, the main body 110 may be a rectangular prism, circular, conical, pentagonal, hexagonal, octagonal, or any other shape known to one of ordinary skill in the art, but is not limited thereto.

The main body 110 may include a plurality of outer blades 111, a plurality of inner blades 112, and a plurality of cake forming apertures 113, but is not limited thereto.

Although, the plurality of outer blades 111, the plurality of inner blades 112, and the plurality of cake forming apertures 113 are referred to in the plurality, each component may be a singular component, such that each component may be referred to as an outer blade 111, an inner blade 112, and a cake forming aperture 113, depending on construction of the main body 110 based on a preference of a user.

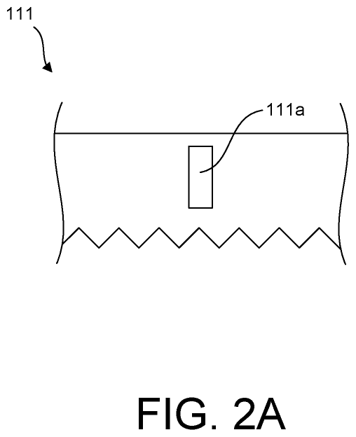

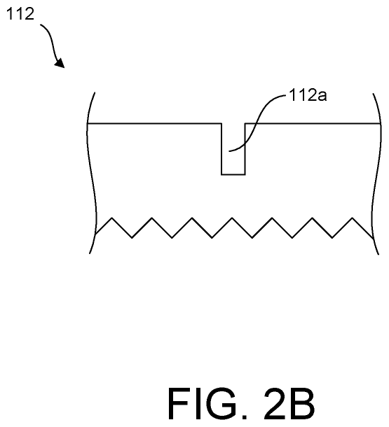

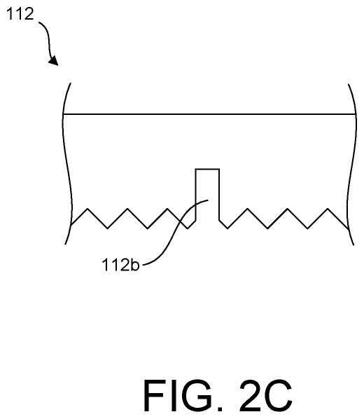

FIG. 2A illustrates a side view of an outer blade 111 with an end receiving groove 111a, according to an exemplary embodiment of the present general inventive concept.

Each of the plurality of outer blades 111 may include at least one end receiving groove 111a, but is not limited thereto.

The plurality of outer blades 111 may be disposed on a perimeter of the main body 110, such that the plurality of outer blades may form a first side, a second side, a third side, and a fourth side of the main body 110.

Referring again to FIG. 1, a length of each of the plurality of outer blades 111 may have differences in length, such that the main body 110 is rectangular. For example, a length of the first side may be equivalent to a length of the third side, which may be greater than or less than a length of the second side and a length of the fourth side. Alternatively, the lengths of each of the plurality of outer blades 111 may be equivalent, such that the main body 110 may be square shaped.

FIG. 2B illustrates a side view of an inner blade 112 with an upper groove 112a, according to an exemplary embodiment of the present general inventive concept.

FIG. 2C illustrates a side view of the inner blade 112 with a lower groove 112b, according to an exemplary embodiment of the present general inventive concept.

Each of the plurality of inner blades 112 may include at least one upper groove 112a and at least one lower groove 112b, but is not limited thereto.

A first set of the plurality of inner blades 112 may be perpendicularly disposed away from at least a portion of a first pair of the plurality of outer blades 111 with respect to a first direction. A second set of the plurality of inner blades 112 may be perpendicularly disposed away from at least a portion of a second pair of the plurality of outer blades 111 with respect to a second direction. Moreover, the first set of the plurality of inner blades 112 may be disposed intermittently along each of the plurality of outer blades 111 intermittently at a first predetermined distance with respect to each other. Furthermore, the second set of the plurality of inner blades 112 may be disposed intermittently at a second predetermined distance with respect to each other, such that the second set is perpendicular with respect to the first set.

As such, the plurality of outer blades 111, the first set of the plurality of inner blades 112, and/or the second set of the plurality of inner blades 112 may collectively form the plurality of cake forming apertures 113 therebetween.

Also, the plurality of cake forming apertures 113 may have a predetermined size and/or a predetermined shape based on the preference of the user. For example, the first predetermined distance may be equivalent to the second predetermined distance, such that the plurality of cake forming apertures 113 may be square shaped and have a size, such as two inches by two inches. Alternatively, the plurality of cake forming apertures 113 may be circular, conical, pentagonal, hexagonal, octagonal, or any other shape known to one of ordinary skill in the art, but is not limited thereto. Additionally, a number of the plurality of cake forming apertures 113 may accommodate a sheet cake, such as a full size of the sheet cake (i.e. 12×18 squares), a half size of the sheet cake (i.e. 6×9 squares), or a quarter size of the sheet cake (i.e. 3×4 squares).

As such, the main body 110 may be referred to have a grid arrangement based on the plurality of cake forming apertures 113.

A size and/or a shape of the main body 110 and/or the plurality of cake forming apertures 113 may be fixed based on the preference of the user. Alternatively, the size and/or the shape of the main body 110 and/or the plurality of cake forming apertures 113 may be adjusted based on the preference of the user.

More specifically, at least a portion of each of the plurality of outer blades 111 and/or at least a portion of each of the plurality of inner blades 112 may be detached and/or connected to each other.

The at least one end receiving groove 111a may be recessed with respect to a surface of each of the plurality outer blades 111. Moreover, a first end and/or a second end of each of the plurality of inner blades 112 may be removably connected to the at least one end receiving groove 111a on at least one of the plurality of outer blades 111, and the second end and/or the first end of each of the plurality of inner blades 112 may be removably connected to another at least one end receiving groove 111a on another at least one of the plurality of outer blades 111 opposite with respect to the at least one of the plurality of outer blades 111, such that at least one of the plurality of inner blades 112 may be connected to (i.e. snap, locked) the at least one end receiving groove 111a and/or the another at least one end receiving groove 111a. In other words, the at least one end receiving groove 111a may receive the first end and/or the second end of the at least one of the plurality of inner blades 112 therein.

Additionally, the at least one upper groove 112a may be disposed on at least a portion of a top surface of each of the plurality of inner blades 112. The at least one lower groove 112b may be disposed on at least a portion of a bottom surface of each of the plurality of inner blades 112. Therefore, the at least one upper groove 112a may be inserted into the at least one lower groove 112b to removably connect (i.e. lock) the at least one of the plurality of inner blades 112 with another at least one of the plurality of inner blades 112. In other words, the at least one lower groove 112b may receive the at least one upper groove 112a therein. Alternatively, the at least one upper groove 112a and/or the at least one lower groove 112b may be separated in response to force applied from the user.

Accordingly, the size and/or the shape of the main body 110 and/or the plurality of cake forming apertures 113 may be adjusted.

Furthermore, at least a portion of the main body 110 may at least partially deform in response to a predetermined pressure level applied, such that other designs may be created on a cake. For example, at least a portion of the plurality of inner blades 112 may at least partially deform to create a dome shape on a cake thereunder, while a perimeter of the cake is rectangular. In other words, the at least a portion of the plurality of inner blades 112 may at least partially deform in response to the predetermined pressure level received from the cake.

The marking assembly 120 may include a serrated edge, a partially serrated edge, and a plain edge, but is not limited thereto.

Referring to FIGS. 1 through 2C, the marking assembly 120 is illustrated to be the serrated edge. However, the marking assembly 120 may be the partially serrated edge and/or the plain edge based on the preference of the user. Also, the serrated edge may have teeth that are spaced at a predetermined interval. For example, the serrated edge may be spaced one quarter of an inch apart, but is not limited thereto. Alternatively, a first portion of the marking assembly 120 may be the serrated edge, a second portion of the marking assembly 120 may be the partially serrated edge, a third portion of the marking assembly 120 may be the plain edge, and/or any combination thereof.

The serrated edge may be used for marking cuts through more firm and hard cakes, such as brownies and fudge composition because serrations grab and mark a surface of the cake better with respect to the plain edge. The plain edge may be used for push marks, which offers better control and accuracy through soft cakes, such as baked cakes.

The marking assembly 120 may be disposed on at least a portion of the bottom surface of the main body 110. Alternatively, the marking assembly 120 may be disposed on an entirety of a bottom surface of the main body 110.

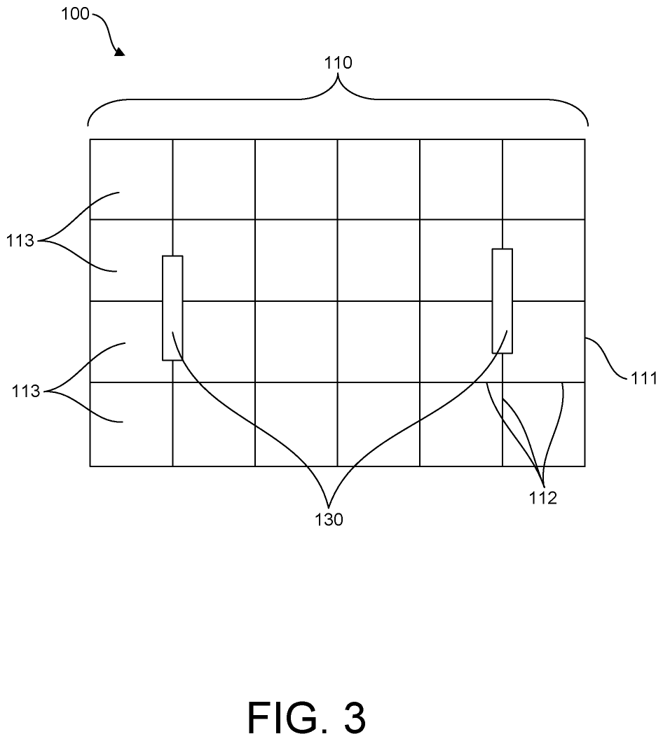

FIG. 3 illustrates a top view of the cake marking device 100, according to an exemplary embodiment of the present general inventive concept.

The plurality of handles 130 may be constructed to have a predetermined height. For example, the plurality of handles 130 may be one and a half to two inches above the main body 110, and have a width of three inches. However, the plurality of handles 130 may have different dimensions based on the preference of the user.

Referring to FIGS. 1 and 3, the plurality of handles 130 may be removably connected to at least a portion of the main body 110. For example, the plurality of handles 130 may be removably connected to at least a portion of the first side and/or at least a portion of the third side. Alternatively, the plurality of handles 130 may be removably connected to at least a portion of the at least one of the plurality of inner blades 112 and/or at least a portion of the another at least one of the plurality of inner blades 112.

The plurality of handles 130 may facilitate gripping thereof. As such, the marking assembly 120 may be directed toward the cake in response to movement of the main body 110 via the plurality of handles 130. As such, the marking assembly 120 may mark the cake in response to contacting the cake, such that the plurality of cake forming apertures 113 form a size and/or a shape of slices of the cake therein.

Therefore, the cake marking device 100 may facilitate marking of the cake by creating predetermined shapes and/or sizes of each slice. Also, the cake marking device 100 may make create even marks that do not depend on a marking skill of the user.

The present general inventive concept may include a cake marking device 100, including a main body 110 including a plurality of outer blades 111 disposed on a perimeter of the main body 110, a plurality of inner blades 112 disposed perpendicularly with respect to at least one pair of the plurality of outer blades 111, and a plurality of cake forming apertures 113 disposed between the plurality of outer blades 111 and the plurality of inner blades 112 to form a size and a shape of slices of the cake therein, a marking assembly 120 disposed on at least a portion of a bottom surface of the main body 110 to mark at least a top surface of a cake in response to contacting the cake, and a plurality of handles 130 removably connected to at least a portion of the main body 130 to facilitate gripping thereof. However, if the main body 110 is pushed through an entire body of the cake, then the cake may be cut by the main body 110 in evenly spaced pieces.

Moreover, it is important to note that the plurality of cake forming apertures 113 may each be two inches by two inches, in order to form cake slices that are exactly an appropriate size for cake slices well known to one of ordinary skill in the art.

Specifically, when it comes to cake sheets for baking cakes, a standard quarter sheet is 9″×13″, a standard half sheet is 13″×18″ and a standard full sheet is 18″×26″. Also, sheet cakes are usually 2 inches in height. As such, for a 2″×2″ serving, a quarter sheet cake has up to 24 serving, a half sheet cake has up to 54 servings, and a full sheet cake has up to 117 servings. As such, the cake marking device 100 may mark and/or cut standard size sheet cake slices having 2″×2″ squares.

Each of the plurality of outer blades 111 may include at least one end receiving groove 111a disposed on at least a portion a surface of each of the plurality of outer blades 111 to receive at least one end of at least one of the plurality of inner blades 112 therein.

The end receiving groove 111a may be recessed with respect to the surface of each of the plurality of outer blades 111.

The plurality of inner blades 112 may include a first set, and a second set perpendicularly disposed with respect to the first set.

Each of the plurality of inner blades 112 may include at least one upper groove 112a disposed on at least a portion of a top surface of each of the plurality of inner blades 112, and at least one lower groove 112b disposed on at least a portion of a bottom surface of each of the plurality of inner blades 112 to receive the at least one upper groove 112a therein, such that the at least one upper groove 112a and the at least one lower groove 112b are locked.

At least a portion of the main body 110 may at least partially deform in response to contact with the cake.

The marking assembly 120 may be a serrated edge.

The marking assembly 120 may be a plain edge.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A cake marking device, comprising:
a main body, comprising:
a plurality of outer blades disposed on a perimeter of the main body,
a plurality of inner blades perpendicularly disposed away from at least one pair of the plurality of outer blades, and
a plurality of cake forming apertures disposed between the plurality of outer blades and the plurality of inner blades to form a size and a shape of slices of the cake therein;
a marking assembly disposed on at least a portion of a bottom surface of the main body to mark at least a top surface of a cake in response to contacting the cake; and
a plurality of handles removably connected to at least a portion of the main body to facilitate gripping thereof.

2. The cake marking device of claim 1, wherein each of the plurality of outer blades comprises:
at least one end receiving groove disposed on at least a portion a surface of each of the plurality of outer blades to receive at least one end of at least one of the plurality of inner blades therein.

3. The cake marking device of claim 2, wherein the end receiving groove is recessed with respect to the surface of each of the plurality of outer blades.

4. The cake marking device of claim 1, wherein the plurality of inner blades comprises:
a first set; and
a second set perpendicularly disposed with respect to the first set.

5. The cake marking device of claim 1, wherein each of the plurality of inner blades comprises:
at least one upper groove disposed on at least a portion of a top surface of each of the plurality of inner blades; and
at least one lower groove disposed on at least a portion of a bottom surface of each of the plurality of inner blades to receive the at least one upper groove therein, such that the at least one upper groove and the at least one lower groove are locked.

6. The cake marking device of claim 1, wherein at least a portion of the main body at least partially deforms in response to contact with the cake.

7. The cake marking device of claim 1, wherein the marking assembly includes a serrated edge.

8. The cake marking device of claim 1, wherein the marking assembly includes a plain edge.
